(19) United States
(12) Patent Application Publication
(10) Pub. No.: US 2013/0246436 A1
(43) Pub. Date: Sep. 19, 2013

(54) SYSTEM AND METHOD FOR DOCUMENT INDEXING AND DRAWING ANNOTATION

(71) Applicant: Russell E. Levine, Highland Park, IL (US)

(72) Inventor: Russell E. Levine, Highland Park, IL (US)

(21) Appl. No.: 13/423,556

(22) Filed: Mar. 19, 2012

(51) Int. Cl. G06F 17/30

(52) U.S. Cl. 707/741; 707/E17.002; 707/E17.005

(57) ABSTRACT

A system and method for parsing a machine-readable document having associated drawing figures with components labeled by references, to identify the occurrence of the references for generating a dynamic reference index table, and for either automatically annotating the references in the associated drawing figures with descriptive words or phrases cross-referenced to the references within the generated dynamic reference index table, or generating a reference usage report identifying inconsistencies and/or errors within the document associated with the identified reference occurrences.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The present application is related to a system and method for parsing and indexing a document, and in particular, to a system and method for parsing a document having associated drawing figures with components labeled with references, such as numerals, letters, symbols or other unique identifiers, for generating a dynamic component label index table, and for automatically annotating the references in the associated drawing figures with dynamic descriptive labels cross-referenced to the references within the generated dynamic component label index table.

Numerous types of documents, such as, but not limited to, published patents, patent application, scientific journal articles, assembly instruction manuals, service manuals, and technical references often contain written descriptions of the subject matter, accompanied by one or more drawing figures. Features or components described in the written description are commonly assigned unique references numerals which correspond to references provided in the drawing figures, enabling a reader to quickly identify a particular feature or component in the drawing figure, or to quickly locate descriptive text in the written description associated with an identified drawing element.

When reading such a document, particularly if the document contains multiple drawings and/or is lengthy, it becomes difficult for a reader to keep track of the specific features or components identified in the drawing figures by the references. Correspondingly, when drafting such a document, a writer may find it difficult to ensure that each unique reference utilized in the document is associated with the correct feature or component, that consistent terminology is employed to describe each occurrence of the feature or component, and to avoid duplicate usage of a unique reference either in the written description or the drawing figures. Prior methods for keeping track are time consuming. For example, some readers will manually write in or annotate the references adjacent to the feature or component in the drawing. Such back and forth between the written description and the drawing figures significantly expands the length of time necessary to review the document. This prior method also is subject to inevitable human error.

Accordingly, there is a need to provide a document editing and analysis tool by which a document, such as, but not limited to, a published patent, patent application, scientific journal article, or other technical reference, containing a written description accompanied by one or more drawing figures having associated references, can by parsed to identify each occurrence of a reference and to associate that occurrence, either in the written description or the drawing figures, with a corresponding word or phrase. A further need is to provide a means by which the drawing figures accompanying the document may be automatically annotated to provide a dynamic written description of each feature or component identified by a reference in the drawing figures. A further need is to provide a means by which the author of the document, or a reader thereof, can determine whether there are inconsistencies or errors in the written description, such a particular component in the drawing that has two or more references within the written description or a particular component that has different words or phrases associated with that component within the written description.

### BRIEF SUMMARY OF THE INVENTION

Briefly stated, the present disclosure provides a software tool for the editing and analysis of an electronic document having machine-readable text, such as, but not limited to, a published patent document, a patent application document, a scientific journal article, assembly instruction manual, service manual, or other technical reference, containing a written description accompanied by one or more drawing figures having associated references which are identified within the written description. The editing and analysis tool, in the form of software instructions configured for directing the operation of a microprocessor or any suitably configured logic circuit or processing system, is configured to initially parse the written description of the document to identify each occurrence of a reference. For each identified occurrence, the editing and analysis tool is configured to extract an associated word or phrase from the document, and to populate a dynamic index table with each reference occurrence, the associated word or phrase, and one or more document location identifiers. The editing and analysis tool is further configured to utilized the dynamic index table to insert dynamic annotations containing the associated words or phrases into either an overlay for the drawing figures, or directly into the drawing figures themselves which accompany the document, at locations which are in proximity to the occurrence of each reference within the drawing figures.

In a further embodiment, the editing and analysis tool of the present disclosure is configured to review the dynamic index table and inserted dynamic annotations for the drawing figures to identify inconsistent usage of words or phrases associated with references, missing references, or other potential errors within the electronic document.

In a further embodiment, the editing and analysis tool of the present disclosure is configured to provide a user with an interface through which the dynamic annotations inserted either directly into the drawing figures, or into an overlay for the drawing figures, may be manipulated by resizing and repositioning as desired by the user, such as to avoid obscuring drawing elements or overlapping text.

In a further embodiment, the present disclosure provides a software tool for the editing and analysis of an electronic document having machine-readable text, such as, but not limited to, a published patent document, a patent application document, a scientific journal article, assembly instruction manual, service manual, or other technical reference, containing a written description accompanied by one or more drawing figures having associated references which are identified within the written description. The editing and analysis tool, in the form of software instructions configured for directing the operation of a microprocessor or any suitably configured logic circuit or processing system, is configured to initially parse the document to identify each occurrence of a reference. For each identified occurrence, the editing and analysis tool is configured to identify an associated word or phrase from the written description of the document, and to populate a dynamic index table with each reference occurrence, the associated word or phrase, and one or more document location identifiers. The editing and analysis tool is further configured to review the dynamic index table to identify inconsistent usage of words or phrases associated with references, missing references, duplicate references, or other potential errors in the usage of references within the electronic document.

A method of the present disclosure provides a process for analysis of an electronic document having machine-readable text, such as a published patent document, a patent application document, a scientific journal article, or other technical reference, containing a written description accompanied by one or more drawing figures having associated references which are identified within the written description. Initially, the written description of the document is parsed to identify each occurrence of a reference. For each identified occurrence, an associated word or phrase is extracted from the written description to populate a dynamic index table containing each reference occurrence, the associated word or phrase, and one or more document location identifiers. The dynamic index table may be searched or sorted by reference, the words or phrases, or by the document location identifiers. Using the data entered into the dynamic index table, each drawing figure accompanying the written description is annotated, either directly or in an overlay, to provide each occurrence of a reference in the drawing figures with an associated dynamic annotation of the corresponding word or phrase from the written description.

In a further embodiment, the dynamic index table and inserted dynamic annotations for the drawing figures are reviewed to identify inconsistent usage of words or phrases associated with references, missing references, duplicate references, or other potential errors within the electronic document.

In a further embodiment, the dynamic annotations inserted either directly into the drawing figures, or into an overlay for the drawing figures, may be manipulated by resizing and repositioning as desired by a user, such as to avoid obscuring drawing elements or overlapping text.

In a further embodiment, the present disclosure provides a process for analysis of an electronic document having machine-readable text, such as a published patent document, a patent application document, a scientific journal article, or other technical reference, containing a written description accompanied by one or more drawing figures having associated references which are identified within the written description. Initially, the document is parsed to identify each occurrence of a reference. For each identified occurrence, an associated word or phrase is extracted from the written description to populate a dynamic index table containing each reference occurrence, the associated word or phrase, and one or more document location identifiers. The dynamic index table may be searched or sorted by reference, the words or phrases, or by the document location identifiers. The dynamic index table is subsequently reviewed to identify to a user any inconsistent usage of words or phrases associated with references, missing references, duplicate references, or other potential errors within the electronic document.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a simplified block diagram of the functional components of the editing and analysis tool of the present disclosure;

FIG. 2 is an illustration of a drawing figure prior to annotation;

FIG. 3 is an illustration of the drawing figure of FIG. 2, annotated by the process of the present disclosure;

FIG. 4 is a representation of the various steps in a process of the present disclosure; and

FIG. 5 is a representation of a visual display of an index table generated by the process of the present disclosure, sorted by document location.

Corresponding references indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

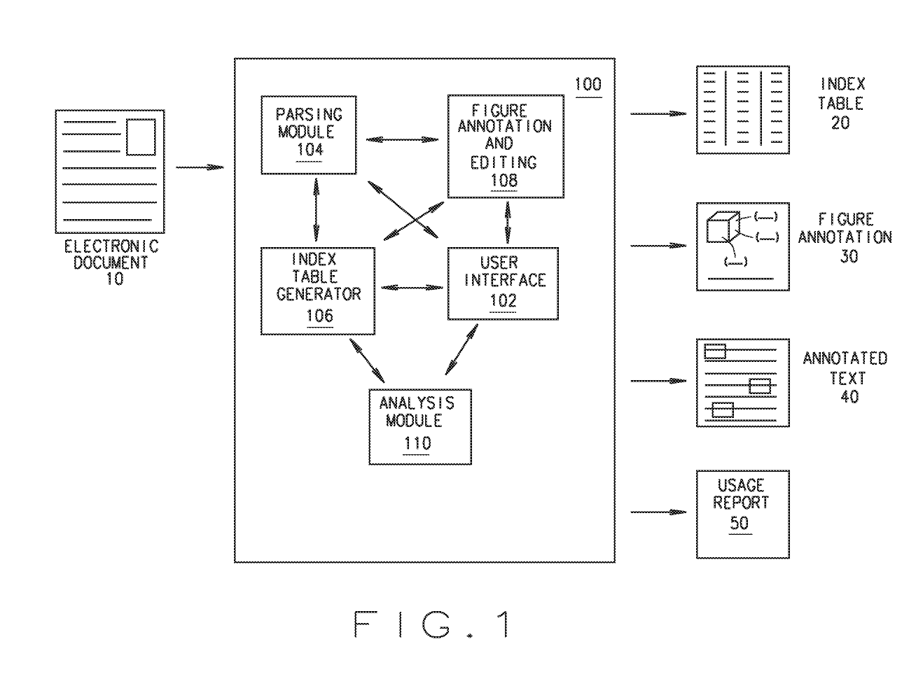

Turing to the Figures, and to FIG. 1 in particular, the present disclosure sets forth a tool or utility program (100) in the form of a set of computer software instructions, for editing and analysis of an electronic document (10) having machine-readable text, containing a written description accompanied by one or more drawing figures having associated references which are identified within the written description. Exemplary electronic documents include, but are not limited to, published patent documents, patent application documents, scientific journal articles, technical references, assembly instruction manuals, and service manuals. The electronic documents may be in an suitable data format in which the text of the documents is, or can be rendered, machine-readable such as through optical character recognition. One exemplary format is the PDF document format available from Adobe Systems, Inc.

The editing and analysis tool (100) can be described as consisting of several modular portions, segments, or components which communicate and/or interact with, and/or share data between, each other to produce the intended output. Those of ordinary skill in the art of computer programming will recognize that while the present disclosure is described as a limited set of modular portions, segments, or components, the actual implementation of the editing and analysis tool (100) in a set of software instructions may consisting of greater or fewer numbers of modular portions, segments or components as required by the specific programming language, the operative functionality chosen by a programmer, and as dictated by the particular hardware platform on which the set of software instructions is to be executed. Accordingly, such variations in implementation, which do not detract from the functionality of the editing and analysis tool (100) as described herein, are considered to be within the scope of the present disclosure.

To provide for interaction with a user, the editing an analysis tool (100) includes a user interface (102) configured to provide a user with the ability to access data files, view data, store data files, and manipulate data files as described below. The user interface (102) may be configured in any of a variety of well-known configurations, including, but not limited to, command-line style interfaces and interactive graphical user interfaces, to provide the user with the functionality required to identify and select an electronic document, initiate document analysis, as well as to review and modify the resulting output.

Within the editing an analysis tool (100), electronic documents selected or opened at the command of an user are initially passed to a set of software instructions which may be defined as a parsing module (104). The parsing module (104) contains software instructions for the primary analysis of an electronic document containing machine-readable text within a written description portion any accompanying figures. Optionally, if the electronic document does not contain machine-readable text, and is in the form of graphic or image data, the parsing module may be configured to perform an optical character recognition analysis on the electronic document image data to generate an associated machine-readable text file on which further processing or parsing may be carried out as set forth herein.

The primary analysis implemented by the parsing module (104) is to scan through the machine-readable text of the written description and figures of the electronic document (10) to identify each occurrence of a reference. References may be identified as alpha-numerical data or symbols enclosed within delimiting markers, such as quotes, parenthesis, or brackets, or may simply be alpha-numerical or symbolic data contained within a string of text. Within a drawing figure, references may be identified as alpha-numeric data associated with a reference line or other identifying indicia, such as underline formatting. Each identified occurrence of a reference is associated with a unique position marker by the parsing module (104) to identify the location of the reference within the electronic document.

Those of ordinary skill in the art will recognize that any of a variety of means may be employed to demark references within an electronic document, and accordingly, that the parsing module (104) is required to be configured with suitable rules or parameters to distinguish references from ordinary text within the document or drawing figures. In addition to a set of standard rules or parameters, the parsing module may optionally include a means for a user to provide customized rules or parameters to distinguish references.

An optional function of the parsing module (104) is to identify the descriptive word or phrase associated with each identified reference occurrence within the written description or drawing figures of the electronic document. Associated descriptive words or phrases may be identified using a variety of techniques. For example, the parsing module (104) may be instructed by a user (through a program setup at the user interface (102)) to simply associate a predetermined number of words which precede each identified reference occurrence with that occurrence of the reference. Alternatively, the parsing module (104) may be provided with instructions to identify delimiting words, such as “a”, “the”, “said”, “an”, etc. within the written description which precede each identified reference occurrence, and to assume that all words appearing between the delimiting words and the identified reference are the accompanying descriptive word or phrase to be associated with that reference occurrence. In addition to a set of standard rules or parameters, the parsing module may optionally include a means for a user to provide customized rules or parameters to distinguish the accompanying descriptive word or phrase for each identified occurrence of a reference.

Data obtained by the parsing module (104), which includes each identified reference occurrence, any accompanying descriptive words or phrases, and the associated unique position markers is communicated with the editing and analysis tool (100) to an index table generating module (106), to populate a dynamic index table (20). The index table generating module (106) may be configured to receive the data sequentially or “in real time” as the parsing module (104) identifies each reference occurrence within the electronic document (10), or may be configured to receive the data as a complete package after the parsing module (104) completes analysis of the electronic document (10). If the parsing module (104) is not configured to identify the descriptive word or phrase associated with each identified reference occurrence within the written description of the electronic document, the index table generating module (106) is configured to implement this functionality in the manner previously described.

In addition to establishing the dynamic index table (20), the index table generating module (106) is configured to receive instructions from the user via the user interface to sort the data contained in the index table (20) in accordance with a provided sort parameter, and to provide output from which the user interface module (102) can generate an associated output of the index table (20) to the user, such as shown in FIG. 5. The output of the index table (20) may be interactive, enabling the user to select, via an interactive icon, a column of data by which to sort the table in either ascending or descending order. The output may be utilized to provide an interactive visual display, a static visual display, or a file suitable for electronic transmission, printing or storage per instruction from the user. As is described further below, the output may include data in a table format, annotated figures, and/or annotated text, as selected by the user through the user interface module (102).

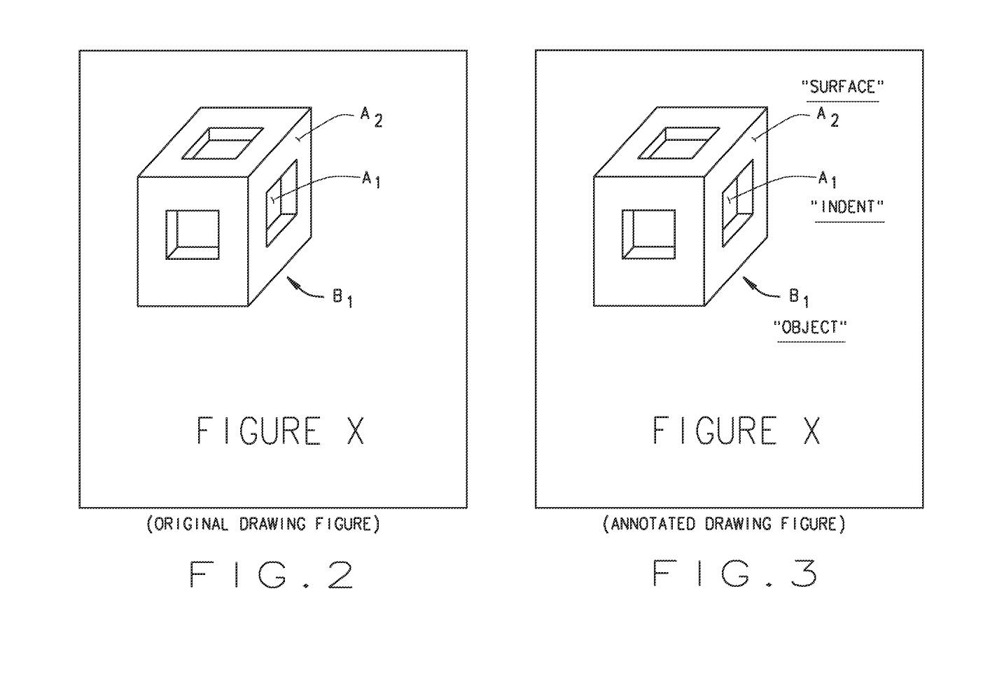

In addition to generating the dynamic index table (20) containing data associated with the identified occurrences of references within the written description of an electronic document, the editing and analysis tool (100) is further configured with a drawing figure annotation module (108). The drawing figure annotation module (108) is a set of software instructions for extracting the reference data from the dynamic index table (20) to annotate any drawing figures contained within the electronic document. The drawing figure annotation module (108) is configured to analyze each drawing figure in the electronic document, such as shown at “Figure X” in FIG. 2, identify the occurrence of each reference in the drawing figure (such as A1, A2, B2 in FIG. 2) and to insert a dynamic reference annotation containing the associated words or phrases for that reference into either an overlay for each drawing figure, or directly into the drawing figures themselves, at locations which are in proximity to the occurrence of each corresponding reference within the drawing figures, as shown in FIG. 3. Those of ordinary skill in the art will recognize that a variety of graphic image editing processes may be utilized by the drawing figure annotation module (108) to produce annotated drawing figures without departing from the scope of the present disclosure.

In one embodiment, the drawing figure annotation module (108) is configured to establish a 1:1 ratio overlay layer for each drawing figure in the electronic document. Dynamic reference annotations are placed on the overlay layer by the drawing figure annotation module at positions which are in proximity to the occurrence of each corresponding reference within the drawing figures. Preferably, the positions are initially selected such that when the drawing figure is viewed by a user through the overlay layer, features of the drawing which are obscured by the annotations are minimized. A user may, through the user interface (102), selectively reposition and/or resize, and/or add or change the color of, any of the dynamic reference annotations. Once the user approves the layout of the drawing figure annotations, the drawing figure annotation module (108) stores the overlay layer in a suitable data storage, and may optionally produce an annotated drawing FIG. 30) as seen in FIG. 3, for display or printing by merging the overlay layer containing the dynamic reference annotations with the underlying drawing figure.

In addition to producing an annotated drawing FIG. 30), the drawing figure module may be configured to utilize the document location identifiers contained within the dynamic index table (20) to produce an annotated or marked-up version (40) of the written description of the electronic document (10), wherein each identified occurrence of a reference, together with the accompanying descriptive word or phrase, is highlighted or marked in a visually distinct manner for the user to review either in the user interface or via a stored / printed copy.

In order to preserve the integrity of the original electronic document (10), it is preferable that the index table (20), the annotated FIGS. 30), and any annotated written descriptions (40) produced by the editing and analysis software (100) be maintained separately from the original electronic document (10), be capable of being saved as a separate electronic documents, and that original electronic document remain unaltered.

In a further embodiment, the editing and analysis tool (100) includes an analysis module (110) which is configured to review the contents of the dynamic index table (20) to identify inconsistent usage of words or phrases associated with identified references, missing or out-of-sequence references, or other potential errors within the electronic document (10). The analysis module (110) is preferably configured to provide the user with a suitable usage report (50) or visual indication which is representative of the results of the index table review procedure. For example, as shown in FIG. 5, the index table data is displayed in an interactive table form, with an additional column in which inconsistent usage and/or identified errors are noted. The analysis module (110) may be configured to function together with the drawing figure annotation module (108), or independently therefrom, to produce a reference usage report (50) without any accompanying annotated drawing FIGS. 30), such as may be beneficial to an author during the drafting of an electronic document.

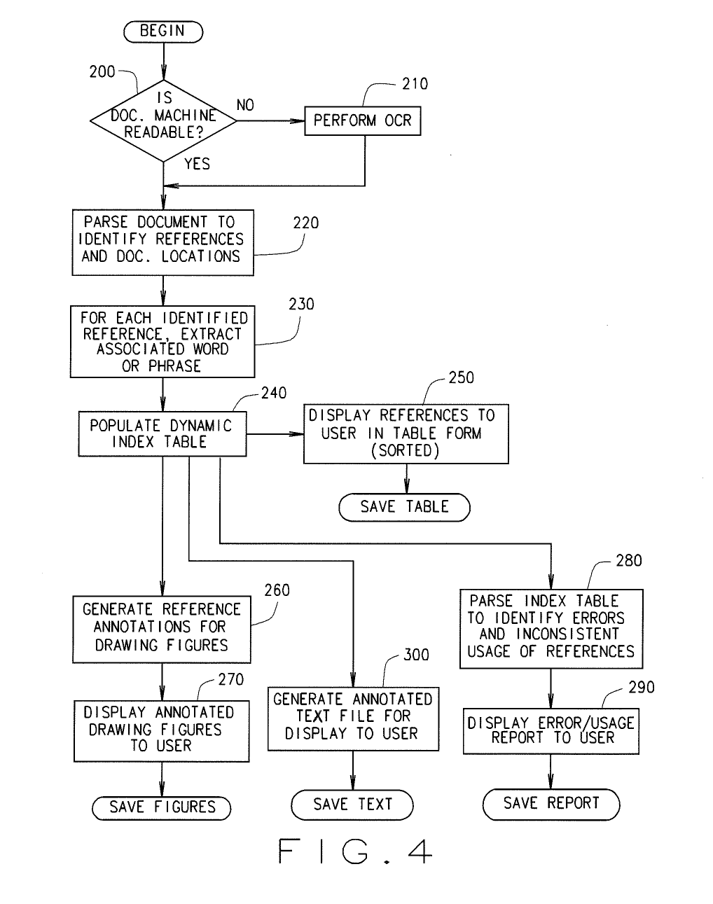

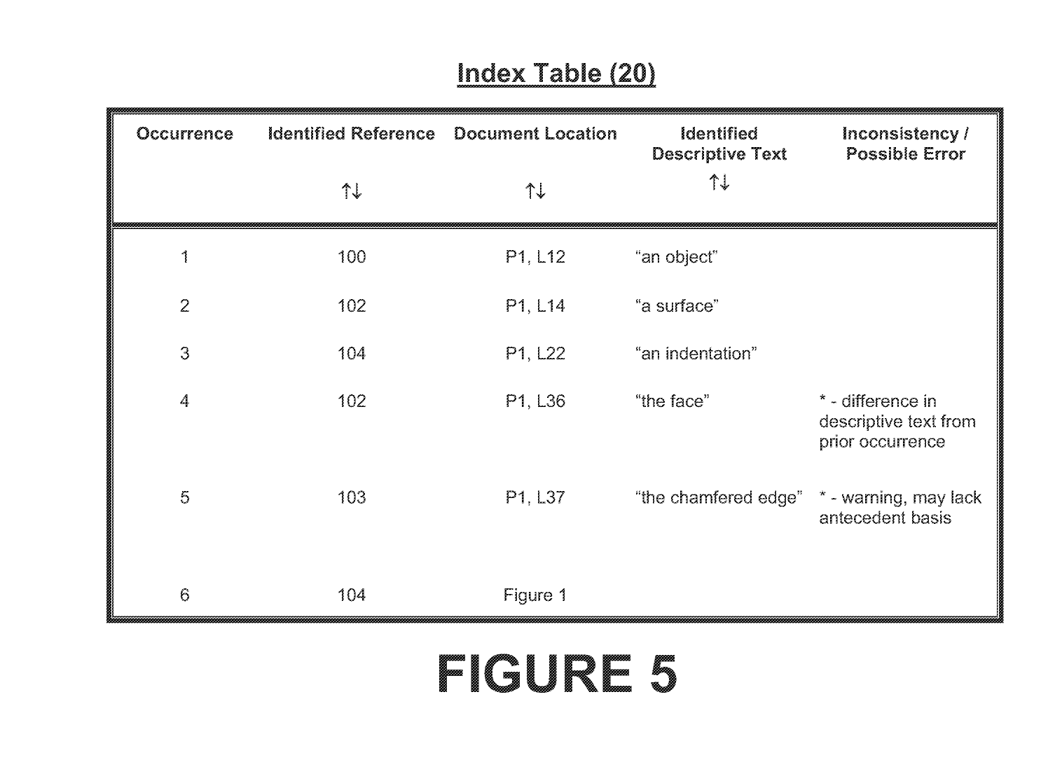

Turning to FIG. 4, a method of the present disclosure for analysis of an electronic document (10) including a written description accompanied by one or more drawing figures having associated references is shown generally. Initially the document is reviewed to determine the presence of machine-readable text (Box 200). If the document is not in a machine-readable format, the document is processed using optical character recognition to produce machine-readable text (Box 210). Once identified or generated, the text of the electronic document is parsed (Box 220) to identify each reference occurrence and an associated document location within the electronic document for subsequent analysis and/or display to a user. For each identified reference occurrence, an associated word or phrase is extracted from the written description or figures (Box 230) using a set of predetermined guidelines or rules. The identified and extracted data is utilized to populate (Box 240) a dynamic index table (20) containing each identified reference occurrence, the associated descriptive words or phrases, and one or more document location identifiers associated with each identified reference occurrence, upon which further document processing is based. Preferably, the dynamic index table (20) is searchable by a user, and the contents may be sorted or re-organized for display (Box 250) in response to user commands.

The contents of the dynamic index table (20) may be further utilized to generate reference annotations (Box 260), including the associated words or phrases, for each occurrence of a reference within the drawing figures of the electronic document (10), and a set of annotated drawing figures are produced (Box 270) which include the generated reference annotations. The annotated drawing figures may be produced using an overlay process or any other suitable graphic-editing / document annotation process, and may be dynamic to permit the user to selectively reposition and/or resize the generated reference annotations with the resulting annotated figures.

Optionally, the method of the present disclosure may include the step of analyzing (Box 280) the populated dynamic index table (20) to identify inconsistencies and/or errors within the electronic document (10) associated with said identified reference occurrences, where the inconsistencies and/or errors include, but are not limited to, duplicate references, missing or out-of-sequence references, and inconsistent usage of associated words or phrases for individual references. The results of the analysis are presented to a user (Box 290) in a suitable format, such as a usage report, containing representations or indications of the identified inconsistencies and/or errors. The usage report may be generated together with the drawing figure annotations (Box 260), or independently therefrom without any accompanying annotated drawing FIGS. (30), such as may be beneficial to an author during the drafting of an electronic document.

Finally, the contents of the dynamic index table (20) may be utilized to generate an annotated version of the electronic document written description, in which each identified occurrence of a reference, together with the associated words or phrases, is highlighted or otherwise marked to provide a visual indication to the user (Box 300).

Those of ordinary skill in the art will recognize that the output produced by the process of the present disclosure, including the populated dynamic index table (Box 240) may, at various stages, be saved, stored, or printed by a user, enabling subsequent access or review without the need to repeat the steps of parsing (Box 220) or identifying (Box 230).

The present disclosure can be embodied in-part in the form of computer-implemented processes and apparatuses for practicing those processes. The present disclosure can also be embodied in-part in the form of computer program code containing instructions embodied in tangible media, or another computer readable storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A computer-implemented software tool for the editing and analysis of an electronic document having machine-readable text containing a written description accompanied by one or more drawing figures having associated references which are identified within the written description, comprising:
a parsing module configured to parse the machine-readable text of the written description and accompanied drawing figures to identify each occurrence of a reference and define an associated document location identifier;
an index generator module configured to receive said identified reference occurrences and said associated document location identifiers from said parsing module and to populate a dynamic index table with each identified reference occurrence and said one or more associated document location identifiers;
wherein ether said parsing module or said index generator module is further configured to extract an associated word or phrase from the document for each identified reference occurrence, and to further populate said dynamic index table with said associated words or phrases for each identified reference occurrence; and
a drawing figure annotation module configured to utilized the contents of the dynamic index table to insert dynamic reference annotations containing the associated words or phrases into either an overlay for each drawing figure, or directly into the drawing figures themselves, at locations which are in proximity to the occurrence of each corresponding reference within the drawing figures, to produce annotated drawing figures.

2. The computer-implemented software tool of claim 1 further including an analysis module configured to utilize the contents of the dynamic index table to identify inconsistencies and/or errors within said electronic document associated with said identified reference occurrences, said inconsistencies and/or errors including, but not limited to, duplicate references, missing references, and inconsistent usage of associated words or phrases for individual references.

3. The computer-implemented software tool of claim 1 wherein said dynamic index table is searchable and sortable by a user through an interface.

4. The computer-implemented software tool of claim 1 wherein said index generator module is further configured to display said dynamic index table to a user.

5. The computer-implemented software tool of claim 1 wherein said index generator module is further configured to generate an output of said dynamic index table, said output adapted for at least one operation including storage, printing, or electronic transmission by a user.

6. The computer-implemented software tool of claim 1 wherein each of said inserted dynamic reference annotations is repositionable and resizable within said overlay or drawing figure in response to user commands.

7. The computer-implemented software tool of claim 1 wherein said drawing figure annotation module is configured to select an insertion location in proximity to the occurrence of each corresponding reference within the drawing figures which minimizes visual overlap between the inserted dynamic reference annotations and features of the drawing figures.

8. The computer-implemented software tool of claim 1 wherein said parsing module is further configured to provide output to a user of each identified occurrence of a reference within the machine-readable text of the written description.

9. The computer-implemented software tool of claim 1 further including a user interface configured to selectively provide output representative of said dynamic index table and said annotated drawing figures.

10. A method for analysis of an electronic document having machine-readable text defining a written description accompanied by one or more drawing figures having associated references which are identified within the written description, comprising:
initially, parsing the electronic document to identify each reference occurrence and an associated document location;
extracting from the written description, for each identified reference occurrence, an associated word or phrase;
populating a dynamic index table with each identified reference occurrence, the associated word or phrase, and one or more document location identifiers associated with each identified reference occurrence;
utilizing the contents of said dynamic index table to generate reference annotations including the associated words of phrases for each occurrence of a reference within said drawing figures; and
providing an annotation of said drawing figures with said generated reference annotations.

11. The method of claim 10 further including the step of analyzing said populated dynamic index table to identify inconsistencies and/or errors within said electronic document associated with said identified reference occurrences, said inconsistencies and/or errors including, but not limited to, duplicate references, missing references, and inconsistent usage of associated words or phrases for individual references; and
providing a user with a representation of said identified inconsistencies and/or errors.

12. The method of claim 10 further including the step of sorting said dynamic index table in response to user input; and providing an output to said user which is representative of said sorted dynamic index table.

13. The method of claim 10 further including the step of searching said dynamic index table in response to user input; and providing an output to said user representative of an associated search result.

14. The method of claim 10 wherein said step of providing an annotation includes providing an overlay for each drawing figure, each of said drawing figure overlays containing said generate reference annotations associated with said drawing figure.

15. The method of claim 10 further including the step of repositioning and/or resizing said generated reference annotations of said drawing figures.

16. The method of claim 15 wherein said repositioning and/or resizing is automatic to minimize visual overlap between said generated reference annotations and features of said drawing figures.

17. The method of claim 15 wherein said repositioning and/or resizing is responsive to user input.

18. The method of claim 15 further including the step of providing a visual representation of each identified reference occurrence within said written description.

19. A computer-implemented software tool for the editing and analysis of an electronic document having machine-readable text containing a written description accompanied by one or more drawing figures having associated references which are identified within the electronic document, comprising:
a means for identifying within the machine-readable text of the electronic document each occurrence of a reference and for defining an associated document location identifier;
a means for generating a dynamic index using said identified reference occurrences and said associated document location identifiers from said means for identifying, said means for generating further capable of extracting an associated word or phrase from said document for each identified reference occurrence, and to populate said dynamic index table with each identified reference occurrence, the associated words or phrases, and said one or more associated document location identifiers;
a means for utilizing the contents of the dynamic index to produce an output for the user, said output consisting of drawing annotations, a reference usage report, or both;
wherein said drawing annotations include one or more dynamic reference annotations containing the associated words or phrases inserted into either an overlay for at least one drawing figure, or directly into the drawing figures themselves, at locations which are in proximity to the occurrence of each corresponding reference within the drawing figures, to produce annotated drawing figures; and
wherein said reference usage report includes an identification of any inconsistencies and/or errors within said electronic document associated with said identified reference occurrences, said inconsistencies and/or errors including, but not limited to, duplicate references, missing references, and inconsistent usage of associated words or phrases for individual references.

20. A computer-implemented software tool for the editing and analysis of an electronic document having machine-readable text containing a written description accompanied by one or more drawing figures having associated references which are identified within the written description, comprising:
a parsing module configured to parse the machine-readable text of the written description and accompanied drawing figures to identify each occurrence of a reference and define an associated document location identifier;
an index generator module configured to receive said identified reference occurrences and said associated document location identifiers from said parsing module and to populate a dynamic index table with each identified reference occurrence and said one or more associated document location identifiers;
wherein ether said parsing module or said index generator module is further configured to extract an associated word or phrase from the document for each identified reference occurrence, and to further populate said dynamic index table with said associated words or phrases for each identified reference occurrence; and
an analysis module configured to utilize the contents of the dynamic index table to identify inconsistencies and/or errors within said electronic document associated with said identified reference occurrences, said inconsistencies and/or errors including, but not limited to, duplicate references, missing references, and inconsistent usage of associated words or phrases for individual references.

21. The computer-implemented software tool of claim 20 further including a drawing figure annotation module configured to utilized the contents of the dynamic index table to insert dynamic reference annotations containing the associated words or phrases into either an overlay for each drawing figure, or directly into the drawing figures themselves, at locations which are in proximity to the occurrence of each corresponding reference within the drawing figures, to produce annotated drawing figures.

23. A method for analysis of an electronic document having machine-readable text defining a written description accompanied by one or more drawing figures having associated references which are identified within the written description, comprising:
initially, parsing the electronic document to identify each reference occurrence and an associated document location;
extracting from the written description, for each identified reference occurrence, an associated word or phrase;
populating a dynamic index table with each identified reference occurrence, the associated word or phrase, and one or more document location identifiers associated with each identified reference occurrence;
analyzing said populated dynamic index table to identify inconsistencies and/or errors within said electronic document associated with said identified reference occurrences, said inconsistencies and/or errors including, but not limited to, duplicate references, missing references, and inconsistent usage of associated words or phrases for individual references; and
providing a user with a representation of said identified inconsistencies and/or errors.

24. The method of claim 23 further including the step of utilizing the contents of said dynamic index table to generate reference annotations including the associated words of phrases for each occurrence of a reference within said drawing figures; and
providing an annotation of said drawing figures with said generated reference annotations.
